(19) United States
(12) Patent Application Publication
(10) Pub. No.: US 2011/0206801 A1
(43) Pub. Date: Aug. 25, 2011

(54) LIQUID-CENTER GUM COMPOSITION

(75) Inventors: Hayato Kajiura, Tokyo (JP); Masaki Yanazaki, Tokyo (JP)

(73) Assignee: LOTTE CO., LTD., Tokyo (JP)

(21) Appl. No.: 12/672,515

(22) PCT Filed: Aug. 5, 2008
(86) PCT No.: PCT/JP2008/064391

§ 371 Date: Feb. 7, 2010

(30) Foreign Application Priority Data
Aug. 9, 2007 (JP) 2007-208438

(51) Int. Cl. A23G 4/20; A23G 4/06

(52) U.S. Cl. 426/5

(57) ABSTRACT

The present invention is to provide a liquid-center gum composition having a gum portion and a liquid portion covered with the gum portion, in which moisture migration from the liquid portion to the gum portion with time can be reduced and desired texture and flavor can be maintained over time. A liquid-center gum composition according to the present invention has a gum portion and a liquid portion covered with the gum portion and characterized in that the liquid portion contains glycerin and a concentration of glycerin relative to the total weight of the liquid portion is 70 wt % to 85 wt %.

### TECHNICAL FIELD

The present invention relates to a liquid-center gum composition, and more particularly, to a liquid-center gum composition comprising a gum portion and a liquid portion covered with the gum portion.

### BACKGROUND ART

Liquid-center gum (hereinafter referred to as “LC gum”) comprising a gum portion and a liquid portion covered with the gum portion, which is chewing gum filled with a liquid containing, for example, a sweetener, has been already known in the art.

Conventional LC gum has a problem in that moisture migrates from a liquid portion to a gum portion with the passage of time, degrading a commercial value of the LC gum. To describe the problem more specifically, when moisture migration occurs, the moisture of the liquid portion first reduces, changing the texture of LC gum when chewed. As a result, desired texture cannot be obtained. Secondly, an aqueous flavor and a taste component contained in the liquid portion migrate to the gum portion together with the moisture, changing the taste of the liquid portion such as flavor. As a result, desired taste cannot be obtained.

To solve these problems, various methods have been proposed for modifying the composition of the liquid portion covered with a gum portion (U.S. Pat. Nos. 3,894,154, 4,156,740, 4,157,402, and 4,466,983). U.S. Pat. No. 3,894,154 is directed to a method of manufacturing a center-in gum by adding a water-miscible moisturizer to a liquid portion for retarding viscosity increase. U.S. Pat. No. 4,156,740 is directed to a method of manufacturing a center-in gum by adding a glycerin moisturizer and another moisturizer to a liquid portion. U.S. Pat. No. 4,157,402 is directed to a method of enhancing flavor-retaining property of a liquid portion by adding an emulsifying agent to a liquid portion. U.S. Pat. No. 4,466,983 is directed to a method of manufacturing a center-in gum by adding a specific component such as glycerin to a liquid portion. In these methods, attempts are made to reduce moisture reduction of a liquid portion caused by migration of moisture from the liquid portion to a gum portion. However, in the LC gum pieces manufactured by these conventional methods, the aforementioned problem has not yet been solved.

On the other hand, to solve these problems, a method for modifying the composition of a gum portion is also proposed (International Publication WO2006/026298). International Publication WO2006/026298 proposes that a gum portion contains a polyol composition comprising maltitol and a liquid portion contains glycerin in an amount of 0 to 65 wt %. However, in the gum composition of International Publication WO2006/026298, migration of moisture from a liquid-filled region to a gum region is not sufficiently reduced.

### DISCLOSURE OF THE INVENTION

The present invention was made to solve the conventional problems mentioned above. It is an object of the present invention to provide a liquid-center gum (LC gum) composition comprising a gum portion and a liquid portion covered with the gum portion, in which moisture migration from the liquid portion to the gum portion with time can be reduced and desired texture and flavor can be maintained over time.

An LC gum composition according to the present invention comprising a gum portion and a liquid portion covered with the gum portion, characterized in that the liquid portion contains glycerin and the concentration of glycerin relative to the total weight of the liquid portion is 70 wt % to 85 wt %.

In the LC gum composition of the present invention, the concentration of glycerin relative to the total weight of the liquid portion is preferably 75 wt % to 80 wt %. In the present invention, the concentration of glycerin capable of reducing moisture migration to a gum portion with time is increased in place of increasing the viscosity of the liquid portion as is performed in the aforementioned conventional methods. This largely depends on the improvement of sealing properties on the gum portion and the technical development of a sweetener such as a sweetener having a high degree of sweetness providing sweetness in a small amount.

In the LC gum composition of the present invention, the liquid portion may further contain at least one element selected from the group consisting of a sugar component, an acidulant, a sweetener, a colorant, a flavor and a thickening agent. In particular, it is preferred to add a sweetener having a high degree of sweetness to the liquid portion, as a sweetener. Since the sweetener having a high degree of sweetness can provide flavor/taste to the liquid portion in a small amount, use of the sweetener is favorable to increase the concentration of glycerin in the liquid portion.

The LC gum composition of the present invention uses glycerin in a liquid portion and the concentration of glycerin relative to the total weight of the liquid portion is 70 wt % to 85 wt %, in particular, 75 wt % to 80 wt %. Owing to this constitution, the LC gum composition of the present invention has an effect of reducing moisture migration with time from the liquid portion to the gum portion and maintaining a desired texture and taste over time.

### BEST MODE FOR CARRYING OUT THE INVENTION

The LC gum composition of the present invention comprises a gum portion and a liquid portion covered with the gum portion. Since the liquid portion contains glycerin and the concentration of glycerin relative to the total weight of the liquid portion is 70 wt % to 85 wt %, moisture migration (a problem in conventional technique) from the liquid portion to the gum portion with time can be reduced.

The liquid (portion), which is present within the gum portion of the LC gum composition of the present invention, spreads throughout the mouth when the gum portion covering the liquid portion is broken by first bite of the gum composition. The liquid portion plays a role in providing texture and flavor that have never ever given by conventional gum pieces. Then, if necessary, to provide desired texture and flavor, etc. to an LC gum composition, the liquid portion may contain a sugar component, an acidulant, a sweetener, a colorant, a flavor and a thickening agent, etc., other than glycerin.

The gum portion of the LC gum composition of the present invention consists of a gum base and a sugar component. As the gum base and sugar component, the materials used in conventional LC gum compositions can be used. In addition, the gum portion may further contain a sugar component, a sweetener, an emulsifying agent, an acidulant, a flavor and a softening agent, etc.

Examples of the sugar component may include erythritol, mannitol, maltitol, xylitol, sorbitol and palatinit. As the gum base, an element selected from various types of polymers, hydrophilic colloids, polyols and/or mixtures thereof known in the art can be used.

Furthermore, in the LC gum composition of the present invention, sugar coating, candy-film and granular coating may be applied to the exterior of the gum portion.

The LC gum composition of the present invention can be manufactured by use of a conventional manufacturing method and apparatus (National Publication Nos. 2004-506434 and 2004-508024). The manufacturing apparatus as disclosed in National Publication No. 2004-506434 is an apparatus for continuously manufacturing tablets of an LC gum composition. In the apparatus, a rope-form gum composition which is filled with a liquid is formed and molded by extrusion. After adjusting the dimensions thereof, the gum composition is separated into tablets individually filled with the liquid. The apparatus has a tablet-forming mechanism having a chain mechanism consisting of pairs of grooved die members (open-form dies mutually combined). By virtue of the structure, a rope-form gum composition is separated and formed into individual pellets.

Examples of the present invention will be explained below; however, the present invention is not limited by the examples explained below.

### Examples 1 to 15 and Comparative Examples 1 to 12

The LC gum tablets according to Examples 1 to 15 and Comparative Examples 1 to 12 were manufactured in accordance with the formulations of a liquid portion and a gum portion of an LC gum composition shown in Tables 1 and 2, respectively, and by varying the blending ratio of glycerin serving as a main component of the liquid portion as shown in Tables 3 to 5.

The LC gum tablets were manufactured first by blending the gum portion and the liquid portion of an LC gum composition in accordance with predetermined formulations. The compositions of the gum portion and the liquid portion were separately loaded to an extruder to form a rope-form LC gum material in which the liquid portion is covered with the gum portion. Subsequently, the rope-form LC gum material was supplied to a manufacturing apparatus as disclosed in National Publication No. 2004-506434 to manufacture tablets of the LC gum composition in a continuous manner.

A gum portion (blended at a temperature 50° C. and kneaded for 20 minutes) and a liquid portion (blended at a temperature of 30 to 50° C. for 20 minutes) were separately prepared. Using the aforementioned manufacturing apparatus, LC gum tablets (each having dimensions: 17.5 mm length×12.5 mm width×7.5 mm thickness and having a weight of about 1.2 g) were manufactured.

### Evaluation Test

The LC gum tablets thus manufactured were sealed with an aluminum-evaporated packaging material and accelerated aging was performed at 40° C. One week later, the solid-content value (hereinafter referred to as “Bx.”) of the center-filled liquid was measured. Bx. was measured by a commercially available Bx.-meter. The Bx.-meter is generally an instrument for measuring the concentration of solid-content. In principle, an optical refractive index increases with an increase of the concentration of solid-content. Based on the principal, measurement is performed. Bx. is an index basically showing the concentration of solid-content of a liquid; however it was used herein as an index showing the moisture content (flowability) of the liquid portion, for convenience sake. Glycerin (purity: 100%) used herein as a raw material is free from the concept of concentration. However, when glycerin is measured by the commercially available Bx.-meter, it shows the same refractive index (Bx. 73) as in maltitol syrup. Accordingly, in this test, the value indicated by the Bx.-meter was used in evaluation of moisture amount (flowability) even in a system containing glycerin. Note that measurement was performed at room temperature (20° C.). A change with the passage of time observed during the storage performed at a temperature of 40° C. for a week corresponds to a change with the passage of time observed during the normal storage performed at normal temperature for 3 months.

The solid content of the center-filled liquid is derived from the solid contents of raw-material syrup (maltitol syrup, sorbitol syrup) and other raw materials. When the moisture of a liquid portion derived from raw material syrup migrates to a gum portion, the moisture of the liquid portion reduces and relatively Bx. increases.

The measurement results are shown in Tables 3 to 5.

TABLE 1
Formulation of liquid portion of LC gum composition

| Component of liquid portion | % by weight |
|---|---|
| Glycerin | 25-90 |
| Maltitol syrup (Bx. 75) | 0-61.2 |
| Sorbitol syrup (Bx. 70) | 0.8-4.6 |
| Acidulant (citric acid) | 8.2 |
| Sweetener having a high degree of | 0.2 |
| sweetness | |
| Colorant | 0.1 |
| Flavor | 0.2 |
| Thickening agent | 0.5 |
| Total | 100.0 |

TABLE 2
Formulation of gum portion of LC gum composition

| Component of gum portion | % by weight |
|---|---|
| Gum base | 27.8 |
| Sugar component | 58.7 |
| (Maltitol, erythritol or mannitol) | |
| Maltitol | 8.9 |
| Sweetener having a high degree of | 0.2 |
| sweetness | |
| Emulsifying agent | 0.1 |
| Acidulant | 1.9 |
| Flavor | 1.4 |
| Softening agent | 1.0 |
| Total | 100.0 |

TABLE 3
Evaluation test for moisture migration to gum portion
one week later depending upon glycerin content (part 1)

| Sugar component used in gum | | | | | | Com. | Com. | Com. | Com. |
|---|---|---|---|---|---|---|---|---|---|
| portion: maltitol | Ex. 1 | Ex. 2 | Ex. 3 | Ex. 4 | Ex. 5 | Ex. 1 | Ex. 2 | Ex. 3 | Ex. 4 |
| Glycerin concentration (wt %) | 70 | 75 | 78 | 80 | 85 | 25 | 50 | 65 | 90 |
| Bx. (%) | 73.0 | 73.0 | 73.0 | 73.0 | 73.0 | 74.5 | 74.0 | 73.2 | 73.0 |

Glycerin concentration is expressed by % by weight relative to the total weight of liquid portion.

TABLE 4
Evaluation test for moisture migration to gum portion
one week later depending upon glycerin content (part 2)

| Sugar component used in gum | | | | | | Com. | Com. | Com. | Com. |
|---|---|---|---|---|---|---|---|---|---|
| portion: erythritol | Ex. 6 | Ex. 7 | Ex. 8 | Ex. 9 | Ex. 10 | Ex. 5 | Ex. 6 | Ex. 7 | Ex. 8 |
| Glycerin concentration (wt %) | 70 | 75 | 78 | 80 | 85 | 25 | 50 | 65 | 90 |
| Bx. (%) | 73.0 | 73.0 | 73.0 | 73.0 | 73.0 | 74.0 | 73.5 | 73.0 | 73.0 |

Glycerin concentration is expressed by % by weight relative to the total weight of liquid portion.

TABLE 5
Evaluation test for moisture migration to gum portion
one week later depending upon glycerin content (part 3)

| Sugar component used in gum | | | | | | Com. | Com. | Com. | Com. |
|---|---|---|---|---|---|---|---|---|---|
| portion: mannitol | Ex. 11 | Ex. 12 | Ex. 13 | Ex. 14 | Ex. 15 | Ex. 9 | Ex. 10 | Ex. 11 | Ex. 12 |
| Glycerin concentration (wt %) | 70 | 75 | 78 | 80 | 85 | 25 | 50 | 65 | 90 |
| Bx. (%) | 73.0 | 73.0 | 73.0 | 73.0 | 73.0 | 74.0 | 73.5 | 73.0 | 73.0 |

Glycerin concentration is expressed by % by weight relative to the total weight of liquid portion.

When any one of the aforementioned sugar components was used in the LC gum composition of the present invention, if the glycerin concentration relative to the total weight of a liquid portion is 70 wt % to 85 wt %, in particular, 75 wt % to 80 wt %, an increase of Bx. was suppressed. As a result, the amount of moisture migrating from a liquid portion to a gum portion decreased. Similarly, when another sugar component conventionally used was used in a gum portion, the same results as above may presumably be obtained.

Note that when the glycerin content exceeds 90 wt %, moisture migration to a gum portion decreases. However, it becomes difficult to dissolve optional additives in a liquid portion, with the result that it is difficult to control flavor and texture of the liquid. The resulting gum is disqualified as an LC gum product. In the case where the primary sugar component of a gum portion was maltitol, as glycerin content decreased from 65 wt % to 50 wt %, moisture migration to a gum portion gradually increased. As a result, the LC gum tablets lost a sense of moisture with time and texture deteriorated. Furthermore, in the case where the primary sugar component of a gum portion consisted of erythritol and mannitol, when the glycerin content was 50 wt % or less, moisture migration to the gum portion increased. As a result, the LC gum tablets lost a sense of moisture with time and texture deteriorated.

In the accelerated aging test performed at 40° C. in examples of the invention, Bx. gradually increases during a week from initiation of the test and thereafter takes a constant value. Note that a time period of a week in the accelerated aging test corresponds to about 3 months in a normal storage state.

### Examples 16 to 30 and Comparative Examples 13 to 24

In the same manner as in Examples 1 to 15 and Comparative Examples 1 to 12, LC gum tablets (each having dimensions: 21.7 mm length×15.0 mm width×8.0 mm thickness and a weight of about 1.8 g) were manufactured and subjected to the same evaluation test.

As a result, no difference was observed in results (change with time) between the LC gum tablets each having dimensions: 17.5 mm length×12.5 mm width×7.5 mm thickness and a weight of about 1.2 g and the LC tablets each having dimensions: 21.7 mm length×15.0 mm width×8.0 mm thickness and a weight of about 1.8 g.

This application claims the benefit of Japanese Patent Application No. 2007-208438, filed Aug. 9, 2007, which is incorporated by reference herein in its entirety.

1. A liquid-center gum composition comprising a gum portion and a liquid portion covered with the gum portion, characterized in that the liquid portion contains glycerin and a concentration of glycerin relative to a total weight of the liquid portion is 70 wt % to 85 wt %.

2. The liquid-center gum composition according to claim 1, wherein the concentration of glycerin relative to a total weight of the liquid portion is 75 wt % to 80 wt %.

3. The liquid-center gum composition according to claim 1, wherein the liquid portion further contains at least one element selected from the group consisting of a sugar component, an acidulant, a sweetener, a colorant, a flavor and a thickening agent.
